(19) United States
(12) Patent Application Publication
(10) Pub. No.: US 2008/0186955 A1
(43) Pub. Date: Aug. 7, 2008

(54) SYSTEMS, METHODS, AND COMPUTER PROGRAM PRODUCTS FOR REGISTERING ENHANCED 911 (E911) INFORMATION USING THE SESSION INITIATION PROTOCOL (SIP)

(75) Inventor: Steven Puckett, Pinson, AL (US)

Correspondence Address: MYERS BIGEL SIBLEY & SAJOVEC, PO BOX 37428, RALEIGH, NC, 27627, US

(73) Assignee: AT&T Intellectual Property, Inc.

(21) Appl. No.: 11/766,508

(22) Filed: Jun. 21, 2007

Related U.S. Application Data
(60) Provisional application No. 60/899,455, filed on Feb. 5, 2007.

(51) Int. Cl. H04L 12/66

(52) U.S. Cl. 370/352

(57) ABSTRACT

A method of registering a physical location of an Internet Protocol (IP) device with an Emergency 911 (E911) system includes subscribing to the IP device using Session Initiation Protocol (SIP), receiving a message containing physical address information associated with the IP device, and storing the physical address information in a location information repository.

### BACKGROUND OF THE INVENTION

This application claims the benefit of and priority to U.S. Provisional Patent Application No. 60/899,455, filed Feb. 5, 2007, the disclosure of which is hereby incorporated herein by reference as if set forth in its entirety.

### BACKGROUND OF THE INVENTION

The present invention relates generally to communication networks and, more particularly, to communication networks that use the Session Initiation Protocol (SIP) to establish communication sessions.

The Internet has become a mainstream network for communicating not just data, such as email and pictures, but also for providing real-time bi-directional voice communications. Voice-Over-Internet-Protocol (VoIP) or Voice-Over-Network (VoN) is an industry standard that has evolved to enable users to place phone calls through the Internet, instead of through the Public Switched Telephone Network (PSTN). Unfortunately, some telephone services traditionally provided via the PSTN may be difficult to provide using VoIP/VoN technology. For example, Enhanced 911 (E911) is a feature of the 911 emergency-calling system that automatically associates a physical address with a calling party's telephone number. This may be done, for example, by a reverse telephone directory that associates the caller's telephone number with a street address. VoIP/VoN phones/devices on the Internet, however, are generally not fixed geographically. Thus, it may be difficult to determine the geographic location or coordinates of an individual placing a 911 call via a VoIP/VoN phone/device.

### SUMMARY

According to some embodiments of the present invention, a method of registering a physical location of an Internet Protocol (IP) device with an Emergency 911 (E911) system includes subscribing to the IP device using Session Initiation Protocol (SIP), receiving a message containing physical address information associated with the IP device, and storing the physical address information in a location information repository.

In other embodiments, storing the physical address information includes determining if the physical address information is different than currently stored physical address information in the location information repository, and storing the physical address information in the location information repository if the physical address information is different than the currently stored physical address information.

In still other embodiments, storing the physical address information includes translating the physical address information from a first format into a second format that is compatible with the location information repository.

In still other embodiments, the first format is an ASCII format.

In still other embodiments, storing the physical address information includes communicating the physical address information to the location information repository using a Web Service and/or an E2 interface.

In still other embodiments, the location information repository is an Automatic Location Information (ALI) database.

In still other embodiments, subscribing to the IP device includes subscribing to a SIP proxy device that is operable as a proxy for the IP device in registering the IP device with a SIP network.

In still other embodiments, the method further includes providing an interactive user interface on the SIP proxy device for entering the physical address information associated with the IP device.

In still other embodiments, the method further includes loading a configuration file on the SIP proxy device that contains the physical address information associated with the IP device.

In still other embodiments, the method further includes providing an interactive user interface on the IP device for entering the physical address information associated with the IP device.

In still other embodiments, the method further includes loading a configuration file on the IP device that contains the physical address information associated with the IP device.

In still other embodiments, receiving the message comprises receiving a message containing physical address information and a SIP phone number associated with the IP device.

In still other embodiments, a computer program product comprising computer-readable program code embodied on a computer-readable medium is configured to carry out the methods discussed above.

In still other embodiments, an E911 system is configured to carry out the methods discussed above.

In further embodiments of the present invention, a method of registering a physical location of an Internet Protocol (IP) device with an Emergency 911 (E911) system includes receiving a message containing physical address information associated with the IP device, translating the physical address information from a first format into a second format that is compatible with a location information repository, and communicating the physical address information to the location information repository using a Web Service and/or an E2 interface.

In still further embodiments, the first format is an ASCII format.

In other embodiments, an Emergency 911 (E911) system includes a location information repository, and an E911 registrar server that is configured to subscribe to an IP device using Session Initiation Protocol (SIP), to receive a message containing physical address information associated with the IP device, and to store the physical address information in the location information repository.

In still other embodiments, the E911 registrar server is further configured to subscribe to the IP device by subscribing to a SIP proxy device that is operable as a proxy for the IP device in registering the IP device with a SIP network.

In still other embodiments, the E911 registrar server is further configured to store the physical address information in the location information repository by translating the physical address information from a first format into a second format that is compatible with the location information repository and communicating the physical address information to the location information repository using a Web Service and/or an E2 interface.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram of a communication network in accordance with some embodiments of the present invention;

FIG. 2 is a block diagram that illustrates a hardware/software architecture for a customer edge device in accordance with some embodiments of the present invention;

FIG. 3 illustrates a user interface for a customer edge device in accordance with some embodiments of the present invention;

FIG. 4 is a block diagram that illustrates a hardware/software architecture for an Emergency 911 (E911) registrar server in accordance with some embodiments of the present invention;

FIG. 5 is a message flow diagram that illustrates operations for registering E911 information in accordance with some embodiments of the present invention;

FIG. 6 is a block diagram of a communication network in accordance with further embodiments of the present invention;

FIG. 7 is a hardware/software architecture for an Internet Protocol (IP) device in accordance with some embodiments of the present invention;

FIG. 8 is a illustrates a user interface for an IP device in accordance with some embodiments of the present invention; and

FIG. 9 is a message flow diagram that illustrates operations for registering E911 information in accordance with further embodiments of the present invention.

### DETAILED DESCRIPTION OF EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as methods, electronic devices/systems, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

As used herein, the term “IP terminal or device” refers to a terminal or device that may communicate using the Session Initiation Protocol (SIP). It will be understood that an IP terminal or device may also refer to devices that communicate using SIP via a media gateway, which translates communications, for example, between an IP network and another network, such as the public switched telephone network or a circuit switched wireless network. As used herein, the term “message” means a unit of information and/or a block of data that may be transmitted electronically as a whole or via segments from one device to another. Accordingly, as used herein, the term “message” may encompass such terms of art as “frame” and/or “packet,” which may also be used to refer to a unit of transmission.

Some embodiments of the present invention arise from a realization that SIP may be used to communicate the physical location of an IP device to an Enhanced 911 (E911) emergency-calling system. Although IP devices may connect to the Internet from a variety of geographic locations, SIP may be used to update the device's current location with the E911 system whenever the device changes location. To facilitate storage of the location information, an E911 registrar server may be configured with software and/or hardware to translate the E911 location information received via SIP into another format suitable for storage in an E911 location information repository.

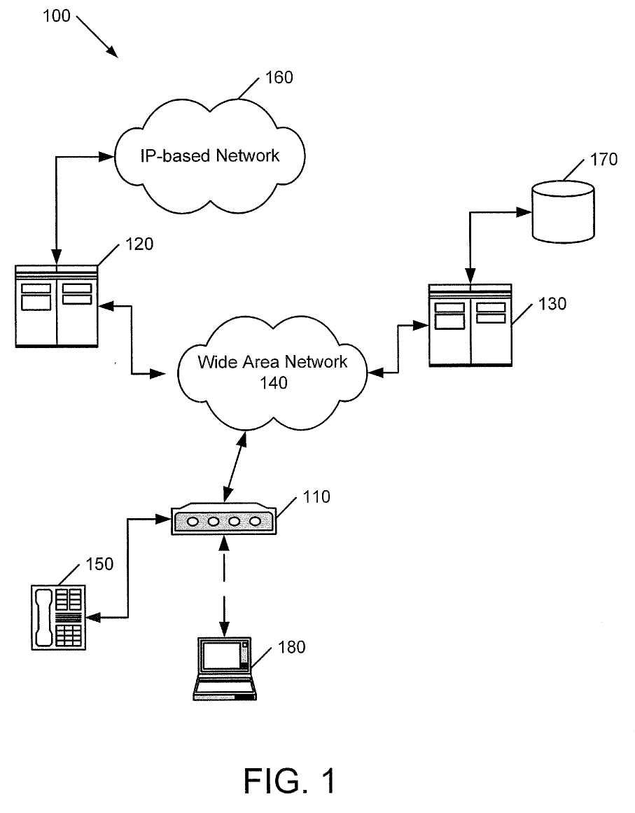

Referring now to FIG. 1, an exemplary communication network 100, in accordance with some embodiments of the present invention, comprises a customer edge device 110, a SIP registrar server 120, and an E911 registrar server 130 that communicate via a Wide Area Network (WAN) 140. The customer edge device 110 may be, for example, a cable modem, DSL modem, or similar device that is used to provide access to the WAN 140 for an IP terminal, such as a SIP phone 150. In some embodiments, the customer edge device 110 may include a communication port that allows a user to configure the edge device 110 via a Graphical User Interface (GUI) and/or command line interface using the SIP phone 150 and/or other input terminal 180. The SIP registrar server 120 is one of several server types that are used to provide the architectural framework for a SIP communication system. These server types include a location server, a redirect server, a proxy server, a presence server, and the registrar server 120. These various server types may be logically distinct functions that are implemented as part of a single entity on one physical server or may be implemented as separate entities distributed across multiple physical servers in accordance with various embodiments of the present invention. The registrar server 120 shown in FIG. 1 may be configured to register IP devices, such as SIP phone 150, when they come on-line and store information on the user's logical identity and the associated device, such as an IP address or Uniform Resource Locator (URL). The registrar server may communicate with other SIP servers via an IP-based network 160, such as the Internet.

The E911 registrar server 130 may be configured to collect information regarding the physical locations of various communication devices and to store that information in a location information repository 170. In some embodiments, the location information repository may be an Automatic Location Information (ALI) database that may be accessed via an E2 Interface and/or a Web Service interface.

The various elements of the communication network 100 may be connected by the WAN 140, such as the Internet or other publicly accessible network. Various elements of the communication network 100 may be interconnected by a wide area network, a local area network, an Intranet, and/or other private network, which may not be accessible by the general public. Thus, the communication network 100 may represent a combination of public and private networks or a virtual private network (VPN). It will be appreciated that the SIP registrar server 120 and/or the E911 registrar server 130 may each be implemented as a single server, separate servers, or a network of servers either co-located in a server farm, for example, or located in different geographic regions. Although FIG. 1 illustrates an exemplary communication network, it will be understood that the present invention is not limited to such configurations, but is intended to encompass any configuration capable of carrying out the operations described herein.

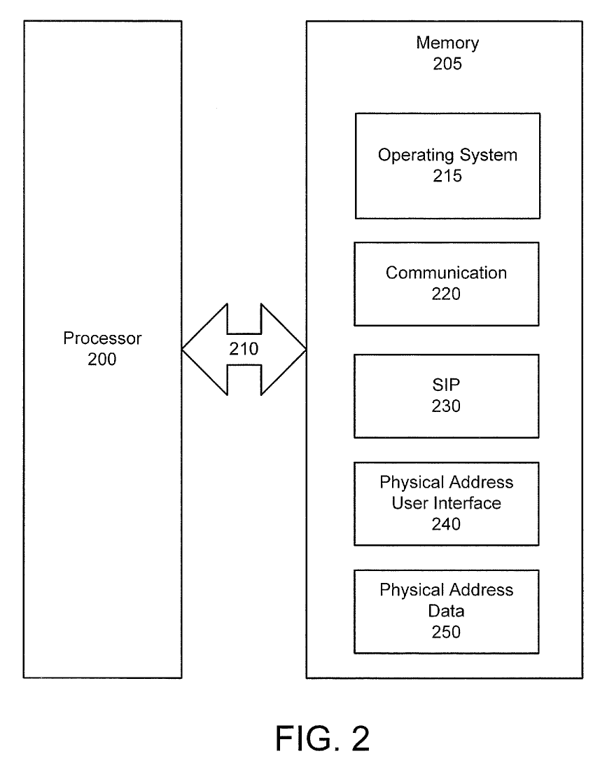

FIG. 2 illustrates a processor 200 and memory 205 that may be used in embodiments of customer edge devices, such as the customer edge device 110 of FIG. 1, in accordance with some embodiments of the present invention. The processor 200 communicates with the memory 205 via an address/data bus 210. The processor 200 may be, for example, a commercially available or custom microprocessor. The memory 205 is representative of the one or more memory devices containing the software and data used for providing an IP device access to the WAN 140 of FIG. 1 in accordance with some embodiments of the present invention. The memory 305 may include, but is not limited to, the following types of devices: cache, ROM, PROM, EPROM, EEPROM, flash, SRAM, and DRAM.

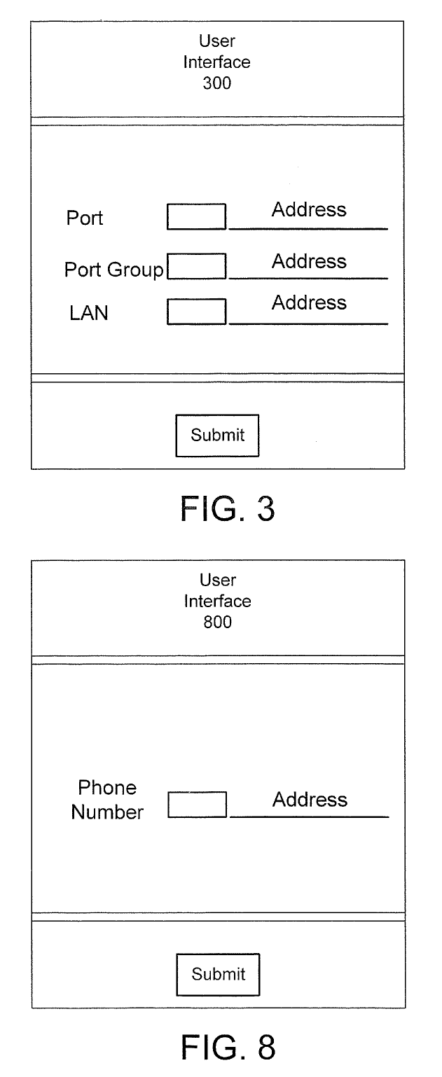

As shown in FIG. 2, the memory 205 may contain five or more categories of software and/or data: an operating system 215, a communication module 220, a SIP module 230, a physical address user interface 240, and physical address data 250. The operating system 215 generally controls the operation of the customer edge device 110. In particular, the operating system 215 may manage the customer edge device's software and/or hardware resources and may coordinate execution of programs by the processor 200. The communication module 220 may be configured to implement the communication protocols for allowing an IP terminal, such as the SIP phone 150 of FIG. 1, to communicate via the WAN 140 of FIG. 1. The SIP module 230 may be configured to implement the SIP application-layer control protocol for establishing, maintaining, and terminating calls between two or more endpoints. The physical address user interface 240 may be used to allow a user to assign a physical address to a specific port, group of ports, and/or a specific network, such as a virtual local area network (VLAN). This is illustrated, for example, in the user interface 300 of FIG. 3 in which a user may use an input device, such as the device 180 of FIG. 1, to assign a physical address to a particular port, port group, and/or LAN. Note that the customer edge device 110 may be configured to provide communication access to multiple IP devices. Accordingly, the physical addresses for the various ports associated with the various IP devices may be assigned via the user interface 300. In some circumstances, groups of ports may share a common physical address, such as the same floor of an office building. In these instances, it may be desirable to assign a common physical address to the entire port group. Similarly, a group of IP devices may communicate via a common LAN and share a common physical address. Thus, one physical address may be assigned for the entire LAN.

Returning to FIG. 2, in other embodiments, the physical address user interface module 240 may be implemented as a command line interface. In still other embodiments, the customer edge device 110 may not include an interactive user interface, but instead may be loaded with a configuration file that includes the physical address information associated with the various IP devices that the customer edge device 110 supports. The physical address data module 250 represents the physical address data associated with the IP devices, such as the SIP phone 150 of FIG. 1, that are communicatively connected to the customer edge device 110.

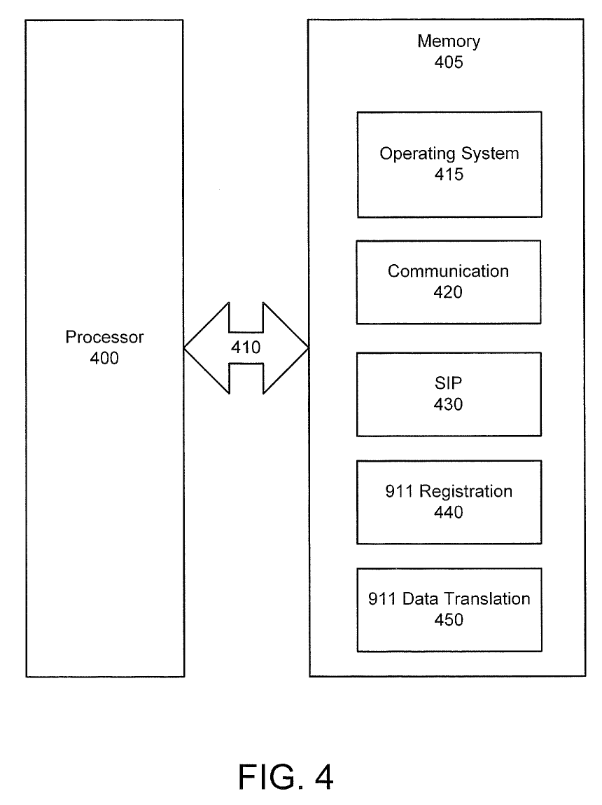

FIG. 4 illustrates a processor 400 and memory 405 that may be used in embodiments of E911 registrar servers, such as the E911 registrar server 130 of FIG. 1, in accordance with some embodiments of the present invention. The processor 400 communicates with the memory 405 via an address/data bus 410. The processor 400 may be, for example, a commercially available or custom microprocessor. The memory 405 is representative of the one or more memory devices containing the software and data used for collecting information regarding the physical locations of various communication devices and for storing that information in a location information repository in accordance with some embodiments of the present invention. The memory 405 may include, but is not limited to, the following types of devices: cache, ROM, PROM, EPROM, EEPROM, flash, SRAM, and DRAM.

As shown in FIG. 4, the memory 405 may contain five or more categories of software and/or data: an operating system 415, a communication module 420, a SIP module 430, an E911 registration module 440, and an E911 data translation module 450. The operating system 415 generally controls the operation of the E911 registrar server 130. In particular, the operating system 415 may manage the E911 registrar server's software and/or hardware resources and may coordinate execution of programs by the processor 400. The communication module 420 may be configured to implement the communication protocols for allowing an E911 registrar server, such as the E911 registrar server 130 of FIG. 1, to communicate via the WAN 140 of FIG. 1. The SIP module 430 may be configured to implement the SIP application-layer control protocol for establishing, maintaining, and terminating calls between two or more endpoints. The E911 registration module 440 may be configured to collect geographic location information, i.e., physical address information, such as mailing address, Global Positioning System (GPS) coordinates, and the like, from communication devices for storage in a location information repository. The E911 data translation module 450 may be configured to translate location information, such as physical address information obtained from the customer edge device 110 of FIG. 1, from the ASCII SIP format into another format that is compatible for storage in the location information repository.

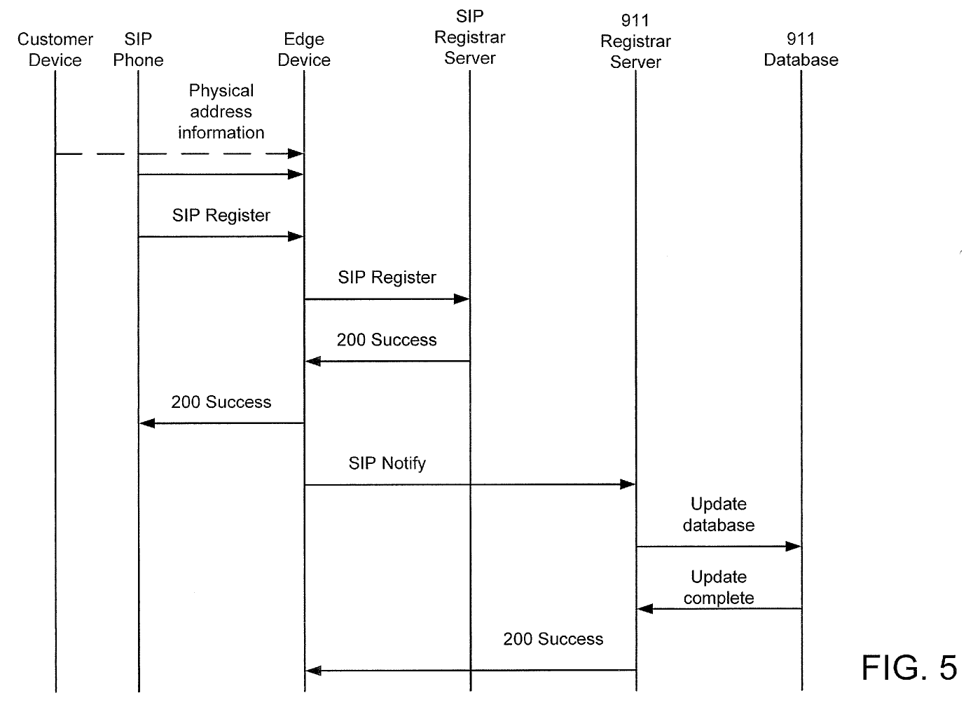

FIG. 5 is a message flow diagram that illustrates operations for registering E911 location information for an IP device with an E911 system using SIP in accordance with some embodiments of the present invention. Operations begin with a user configuring the edge device 10 with the physical address information associated with an IP device, such as the SIP phone 150 of FIG. 1. The physical address information may be stored in the customer edge device 110 using the SIP phone 150 or input device 180 via a user interface (e.g., GUI or command line interface) provided by the customer edge device 110 and/or via a configuration file as discussed above.

When the SIP phone 150 is turned on, it will send a SIP Register message to the customer edge device 110. The customer edge device 110 acts as a proxy and forwards the SIP register message to the SIP registrar server 120. The SIP registrar server 120 registers the logical identity of the user of the SIP phone 150 along with the IP address/URL of the SIP phone 150 and responds with a SIP status code 200 acknowledgement, which indicates the registration was successful. The customer edge device 110 receives the SIP success acknowledgement and forwards it to the SIP phone 150.

The E911 registrar server 130 may use SIP to subscribe to the customer edge device 110 to obtain physical address information from the customer edge device 110 when an IP device registers. Thus, after the SIP phone 150 has successfully registered with the SIP registrar server 120, the customer edge device 110 may send a SIP Notify message to the E911 server 130 containing the physical address information and/or SIP phone number associated with the SIP phone 150, which is stored on the customer edge device 110. Upon receiving the physical address information for the SIP phone 150 via the SIP Notify message, the E911 registrar server 130 may use the E911 data translation module 450 of FIG. 4 to translate the ASCII encoded physical address information for the SIP phone 150 into a format that is suitable for storage in the location information repository 170 of FIG. 1. The E911 registrar server 130 may, in some embodiments, determine if the physical address information for the SIP phone 150 has changed since the last time that the SIP phone 150 performed a SIP register operation. If the physical address information has not changed, then the E911 registrar server 130 need not update the location information repository 170 for the SIP phone 150. If the physical address information has changed, however, then the E911 registrar server 130 may update the physical address information in the location information repository 170 using a Web Service and/or an E2 interface, which is a standard interface for communicating location information to a location information repository, such as a 911 Automatic Location Information database.

The location information repository 170 may provide an indication to the E911 registrar server 130 that the physical address information for the SIP phone 150 has been successfully updated. The E911 registrar server 130 may then send a SIP success acknowledgement to the customer edge device 110 to acknowledge the successful notification of the physical address information for the SIP phone 150. The customer edge device 110 may now allow the SIP phone 150 to make calls via the WAN 140 as the geographic location information for the SIP phone 150 has been successfully updated in the E911 system.

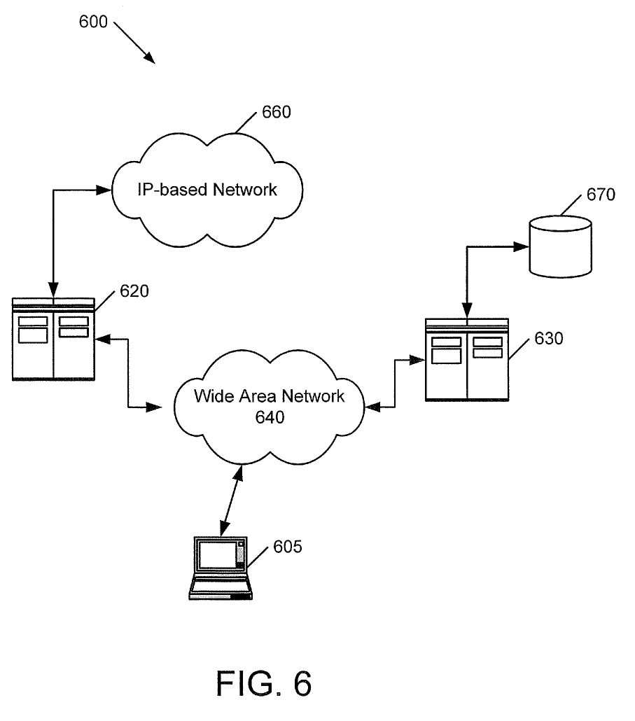

Referring now to FIG. 6, an exemplary communication network 600 in accordance with further embodiments of the present invention will now be described. The communication network 600 is similar to the communication network 100 of FIG. 1. Accordingly, the SIP registrar server 620, E911 registrar server 630, WAN 640, IP-based network 660, and location information repository 670 are similar to the corresponding components described above with respect to FIG. 1 and their description will not be repeated. In the communication network 600, however, an IP device 605, such as a SIP softphone, for example, connects directly to the WAN 640 rather than through an edge device.

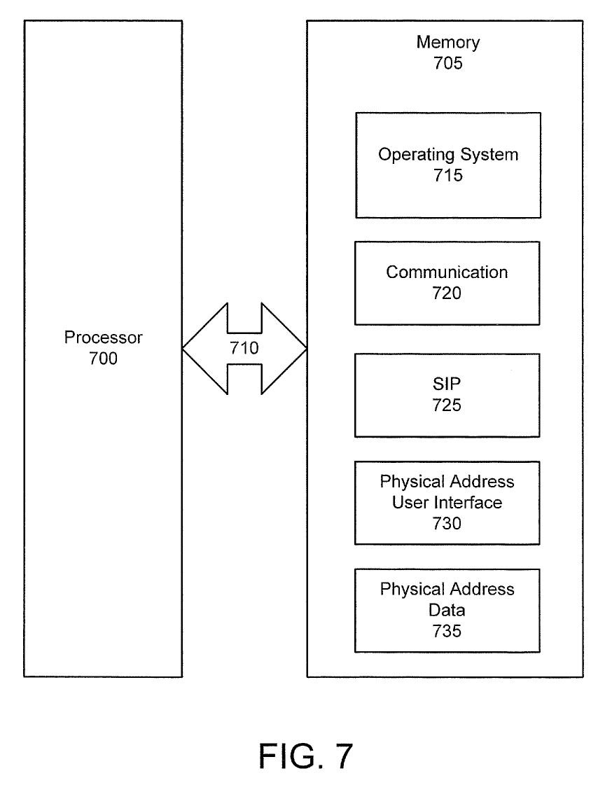

FIG. 7 illustrates a processor 700 and memory 705 that may be used in embodiments of IP devices, such as the SIP softphone 605 of FIG. 6, in accordance with some embodiments of the present invention. The processor 700 communicates with the memory 705 via an address/data bus 710. The processor 700 may be, for example, a commercially available or custom microprocessor. The memory 705 is representative of the one or more memory devices containing the software and data used for providing access to the WAN 640 of FIG. 6 in accordance with some embodiments of the present invention. The memory 705 may include, but is not limited to, the following types of devices: cache, ROM, PROM, EPROM, EEPROM, flash, SRAM, and DRAM.

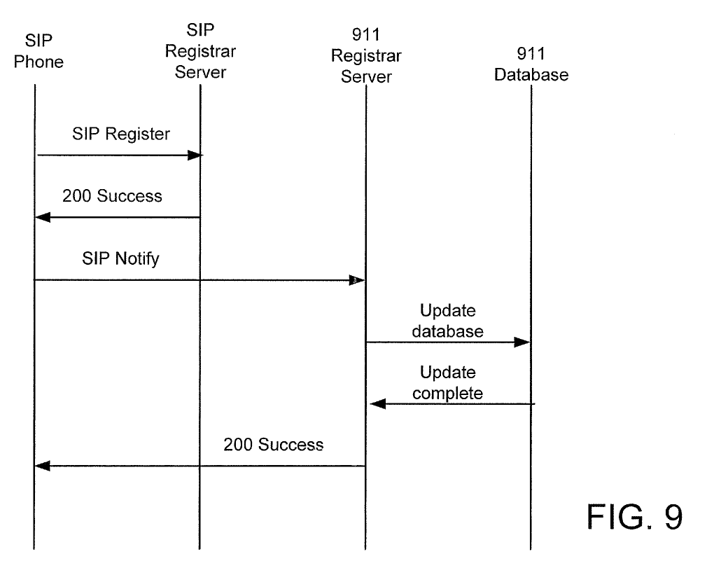

As shown in FIG. 7, the memory 705 may contain five or more categories of software and/or data: an operating system 715, a communication module 720, a SIP module 730, a physical address user interface 730, and physical address data 735. The operating system 715 generally controls the operation of the IP device. In particular, the operating system 715 may manage the IP device's software and/or hardware resources and may coordinate execution of programs by the processor 700. The communication module 720 may be configured to implement the communication protocols for allowing an IP device, such as the SIP softphone 605 of FIG. 6, to communicate via the WAN 640 of FIG. 6. The SIP module 725 may be configured to implement the SIP application-layer control protocol for establishing, maintaining, and terminating calls between two or more endpoints. The physical address user interface 730 may be used to allow a user to assign a physical address to the IP device. This is illustrated, for example, in the user interface 800 of FIG. 8 in which a user may use an IP device, such as the SIP softphone 605 of FIG. 6, to assign a physical address to the device. As shown in FIG. 8, a user may associate a physical address with the phone number for the IP device.

Returning to FIG. 7, in other embodiments, the physical address user interface module 730 may be implemented as a command line interface. In still other embodiments, the IP device may not include an interactive user interface, but instead may be loaded with a configuration file that includes the physical address information associated with IP device. The physical address data module 735 represents the physical address data associated with the IP device, such as the SIP softphone 605 of FIG. 6.

FIG. 9 is a message flow diagram that illustrates operations for registering E911 location information for an IP device with an E911 system using SIP in accordance with further embodiments of the present invention. The IP device includes physical address information that has been entered by a user using a GUI, command line interface, and/or configuration file as discussed above. Operations begin with a user turning the SIP softphone 605 on causing it to send a SIP register message to the SIP registrar server 620. The SIP registrar server 120 registers the logical identity of the user of the SIP softphone 605 along with the IP address/URL of the SIP softphone 605 and responds with a SIP success acknowledgement.

The E911 registrar server 630 may use SIP to subscribe to the SIP softphone 605 to obtain physical address information from the SIP softphone 605 when the phone registers. Thus, after the SIP softphone 605 has successfully registered with the SIP registrar server 620, the SIP softphone 605 may send a SIP Notify message to the E911 server 630 containing the physical address information and/or SIP phone number associated with the SIP softphone 605. Upon receiving the physical address information for the SIP softphone 605 via the SIP Notify message, the E911 registrar server 630 may use the E911 data translation module 450 of FIG. 4 to translate the ASCII encoded physical address information for the SIP softphone 605 into a format that is suitable for storage in the location information repository 670. The E911 registrar server 630 may, in some embodiments, determine if the physical address information for the SIP softphone 605 has changed since the last time that the SIP softphone 605 performed a SIP register operation. If the physical address information has not changed, then the E911 registrar server 630 need not update the location information repository 670 for the SIP softphone 605. If the physical address information has changed, however, then the E911 registrar server 630 may update the physical address information in the location information repository 670 using a Web Service and/or an E2 interface.

The location information repository 670 may provide an indication to the E911 registrar server 630 that the physical address information for the SIP softphone 605 has been successfully updated. The E911 registrar server 630 may then send a SIP success acknowledgement to the SIP softphone 605 to acknowledge the successful notification of the physical address information for the SIP softphone 605. The SIP softphone 605 may now allow a user to make calls via the WAN 640 as the geographic location information for the SIP softphone 605 has been successfully updated in the E911 system.

As discussed above, some embodiments of the present invention may allow IP devices to register their locations with an E911 system using SIP. In accordance with various embodiments of the present invention, the location information may be communicated directly from an IP device or via proxy through a customer edge device that stores the location for one or more IP devices. This may allow IP devices, which are generally not confined to specific geographic locations, to to take advantage of the services provided through the E911 system.

Computer program code for carrying out operations of devices and/or systems discussed above may be written in a high-level programming language, such as Java, C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

The present invention has been described above with reference to message flow diagram illustrations of methods, devices, servers, and/or computer program products in accordance with some embodiments of the invention. These message flow diagrams further illustrate exemplary operations of registering location information with an E911 system using SIP in accordance with some embodiments of the present invention. It will be understood that each message, and combinations of messages in the message flow diagram illustrations, may be generated/implemented by computer program instructions and/or hardware operations. These computer program instructions may be provided to a processor of a general-purpose computer, a special purpose computer, or other programmable data processing apparatus to produce a machine, such that the instructions, which execute via the processor of the computer or other programmable data processing apparatus, create means for implementing the functions specified in the message flow diagram(s).

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the message flow diagram(s).

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the message flow diagram(s).

Many variations and modifications can be made to the embodiments without substantially departing from the principles of the present invention. All such variations and modifications are intended to be included herein within the scope of the present invention, as set forth in the following claims.

That which is claimed:

1. A method of registering a physical location of an Internet Protocol (IP) device with an Emergency 911 (E911) system, comprising:
subscribing to the IP device using Session Initiation Protocol (SIP);
receiving a message containing physical address information associated with the IP device; and
storing the physical address information in a location information repository.

2. The method of claim 1, wherein storing the physical address information comprises:
determining if the physical address information is different than currently stored physical address information in the location information repository; and
storing the physical address information in the location information repository if the physical address information is different than the currently stored physical address information.

3. The method of claim 1, wherein storing the physical address information comprises:
translating the physical address information from a first format into a second format that is compatible with the location information repository.

4. The method of claim 3, wherein the first format is an ASCII format.

5. The method of claim 1, wherein storing the physical address information comprises:
communicating the physical address information to the location information repository using a Web Service and/or an E2 interface.

6. The method of claim 1, wherein the location information repository is an Automatic Location Information (ALI) database.

7. The method of claim 1, wherein subscribing to the IP device comprises:
subscribing to a SIP proxy device that is operable as a proxy for the IP device in registering the IP device with a SIP network.

8. The method of claim 7, further comprising:
providing an interactive user interface on the SIP proxy device for entering the physical address information associated with the IP device.

9. The method of claim 7, further comprising:
loading a configuration file on the SIP proxy device that contains the physical address information associated with the IP device.

10. The method of claim 1, further comprising:
providing an interactive user interface on the IP device for entering the physical address information associated with the IP device.

11. The method of claim 1, further comprising:
loading a configuration file on the IP device that contains the physical address information associated with the IP device.

12. The method of claim 1, wherein receiving the message comprises:
receiving a message containing physical address information and a SIP phone number associated with the IP device.

13. A computer program product comprising computer-readable program code embodied on a computer-readable medium, the computer readable program code being configured to carry out the method of claim 1.

14. An E911 system configured to carry out the method of claim 1.

15. A method of registering a physical location of an Internet Protocol (IP) device with an Emergency 911 (E911) system, comprising:
receiving a message containing physical address information associated with the IP device;
translating the physical address information from a first format into a second format that is compatible with a location information repository; and
communicating the physical address information to the location information repository using a Web Service and/or an E2 interface.

16. The method of claim 15, wherein the first format is an ASCII format.

17. An E911 system configured to carry out the method of claim 15.

18. An Emergency 911 (E911) system, comprising:
a location information repository; and
an E911 registrar server that is configured to subscribe to an IP device using Session Initiation Protocol (SIP), to receive a message containing physical address information associated with the IP device, and to store the physical address information in the location information repository.

19. The E911 system of claim 18, wherein the E911 registrar server is further configured to subscribe to the IP device by subscribing to a SIP proxy device that is operable as a proxy for the IP device in registering the IP device with a SIP network.

20. The E911 system of claim 18, wherein the E911 registrar server is further configured to store the physical address information in the location information repository by translating the physical address information from a first format into a second format that is compatible with the location information repository and communicating the physical address information to the location information repository using a Web Service and/or an E2 interface.
